(19) United States
(12) Patent Application Publication
(10) Pub. No.: US 2015/0078988 A1
(43) Pub. Date: Mar. 19, 2015

(54) Hydrogen Separation for Hydrocarbon Reforming Gas

(71) Applicant: CERAMATEC, INC., Salt Lake City, UT (US)

(72) Inventor: Ashok V. Joshi, Salt Lake City, UT (US)

(21) Appl. No.: 14/471,675

(22) Filed: Aug. 28, 2014

Related U.S. Application Data
(60) Provisional application No. 61/872,051, filed on Aug. 30, 2013.

(51) Int. Cl. C01B 3/56

(52) U.S. Cl. CPC C01B 3/56; C01B 2203/0475; C01B 2203/047; C01B 2203/048; C01B 2203/042; C01B 2203/0405
USPC 423/658.3

(57) ABSTRACT

A process involves separating hydrogen that is produced from a reformer. Specifically, the products, which include hydrogen, CO₂ and hydrocarbons, are added to a CaO bed. The CaO reacts with the CO₂ to form CaCO₃, thereby removing CO₂ from the products. The remaining products (e.g., hydrocarbons and hydrogen) may be separated using a hydrogen-sensitive membrane. This membrane will produce a refined, purified supply of hydrogen gas.

### CROSS-REFERENCE TO RELATED APPLICATIONS

This application claims the benefit of U.S. Provisional Application No. 61/872,051, filed Aug. 30, 2013, entitled “Hydrogen Separation from Hydrocarbon Reforming Gas” the entire disclosure of which is hereby incorporated by reference.

### TECHNICAL FIELD

The present application relates to producing hydrogen gas (H₂). More specifically, the present embodiments involve separating hydrogen gas that is produced from CO, CO₂ and other materials, so that this H₂ gas may be used to further process hydrocarbons.

### BACKGROUND

Hydrogen gas is used to process hydrocarbons that are extracted from the earth. For example, a common process at an oil refinery (or other refinery) is “hydrocracking” whereby hydrogen gas (and a catalyst) is used to break down larger hydrocarbon materials into methane gas and other lighter, usable hydrocarbon. Other refining processes also use hydrogen gas to further process hydrocarbon materials and convert them into usable fuels, etc.

Hydrogen gas is commercially formed in the United States using the “Steam Methane Reforming Process.” This process is summarized as follows:

CH₄+H₂O═CO+3H₂

In this Steam Methane Reforming process, methane (or another hydrocarbon) is reacted at high temperatures (such as 700-1100° C.) and in the presence of a metal-based catalyst (such as nickel), steam reacts with the hydrocarbon to produce carbon monoxide and hydrogen gas.

However, in order to use the hydrogen gas formed by the Steam Methane Reforming process, the hydrogen gas must be separated out from the other products (e.g., the CO and any unreacted hydrocarbon starting material). Unfortunately, this separation process can be difficult. One method for separating out the hydrogen may involve using a hydrogen membrane; yet, the use of such membranes can be difficult as these membranes are sensitive to temperature as well as impurities in the sample. Accordingly, these membranes may be fouled by the impurities or may not work optimally based upon the temperature of the sample. For this reason, a new separation technology is needed. Such a process is disclosed herein.

### SUMMARY

This invention involves methods for separating hydrogen out of the products formed from a reforming process. In general, these products may include CO, CO₂, H₂, other hydrocarbons, nitrogen, and/or oxygen. Specifically, the carbon dioxide (if present) is removed. Then, the mixture is added to a bed of CaO (or MgO, or combinations of both). The CaO reacts with the CO₂ to form CaCO₃ (or MgCO₃). Once the CO₂ is removed in this manner, the remaining products (which include hydrogen gas and unreacted hydrocarbons and/or nitrogen and oxygen) may be passed through a hydrogen membrane. This hydrogen membrane may remove the hydrogen from the other products, such that pure or substantially pure hydrogen gas is obtained. This hydrogen gas may then be used for other reactions in the refinery process.

It should be noted that once the CaO has reacted with the CO₂ to form CaCO₃, the CaCO₃ may be heated to release the CO₂, thereby allowing the CaO to be used in a further reaction. In some embodiments, there may be two (2) distinct beds of CaO. Of these two beds, one is actively reacting with the CO₂, while the other reactor is being heated to empty the CO₂ (and reform the CaO). Thus, when one bed is full (and can no longer react with further quantities of CO₂), the other CaO bed is used and the first (full) bed will be heated to remove the CO₂. In this manner, there may always be a bed of CaO that is reacting.

### BRIEF DESCRIPTION OF THE SEVERAL DRAWINGS

In order that the manner in which the above-recited and other features and advantages of the invention are obtained and will be readily understood, a more particular description of the invention briefly described above will be rendered by reference to specific embodiments thereof that are illustrated in the appended drawings. Understanding that the drawings depict only typical embodiments of the invention, are not necessarily drawn to scale, and are not therefore to be considered to be limiting of its scope, the invention will be described and explained with additional specificity and detail through the use of the accompanying drawings in which:

FIG. 1 depicts a schematic diagram of a representative embodiment of a device that may be used to separate hydrogen from a chemical reaction;

FIG. 2 depicts schematic diagram of another representative embodiment of a device that may be used to separate hydrogen from a chemical reaction; and

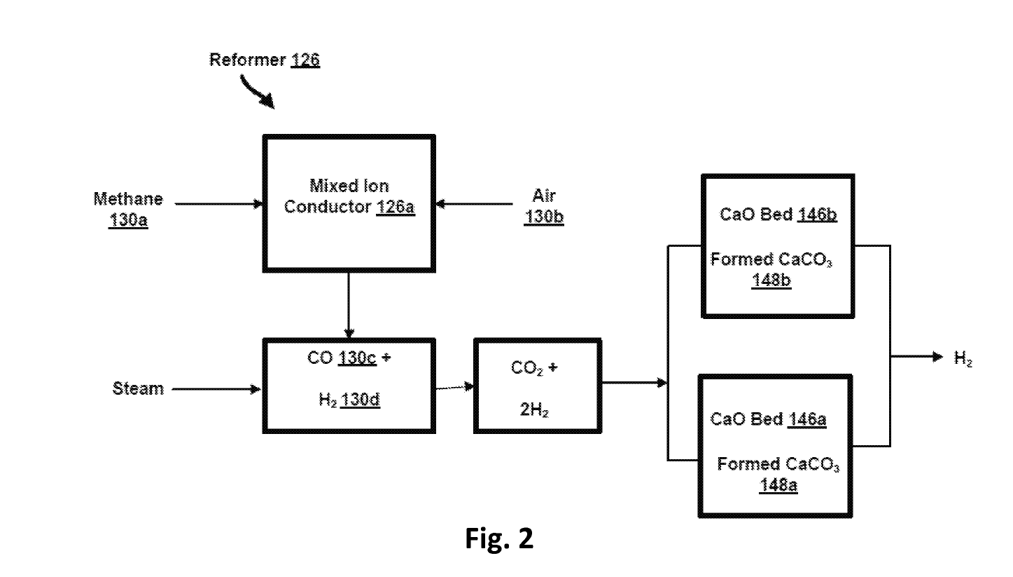

FIG. 3 depicts schematic diagram of another representative embodiment of a device that may be used to separate hydrogen from a chemical reaction.

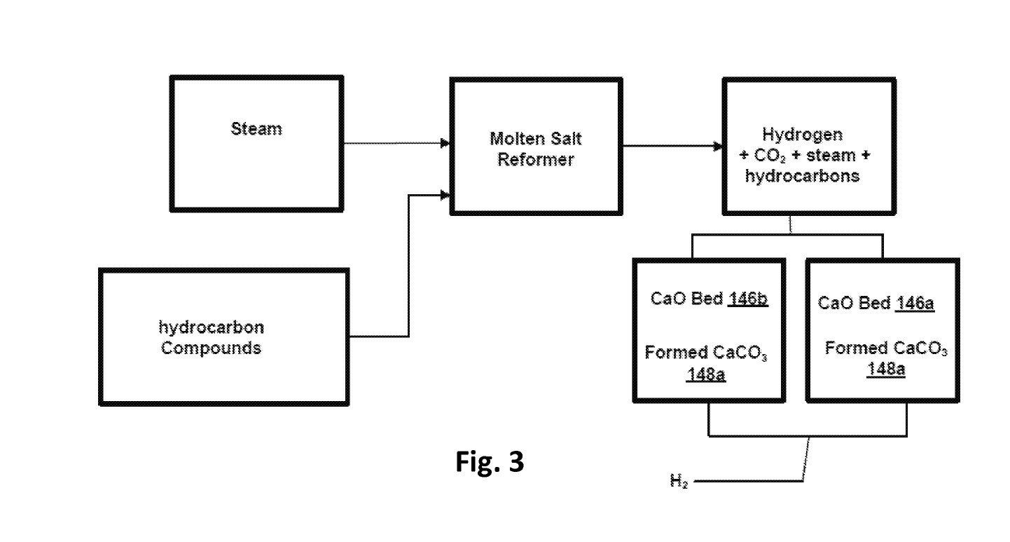

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment. Additionally, while the following description refers to several embodiments and examples of the various components and aspects of the described invention, all of the described embodiments and examples are to be considered, in all respects, as illustrative only and not as being limiting in any manner.

Furthermore, the described features, structures, or characteristics of the invention may be combined in any suitable manner in one or more embodiments. In the following description, numerous specific details are provided, such as examples of suitable ceramics, joint initiators, heating methods, cleaning methods, etc., to provide a thorough understanding of embodiments of the invention. One having ordinary skill in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

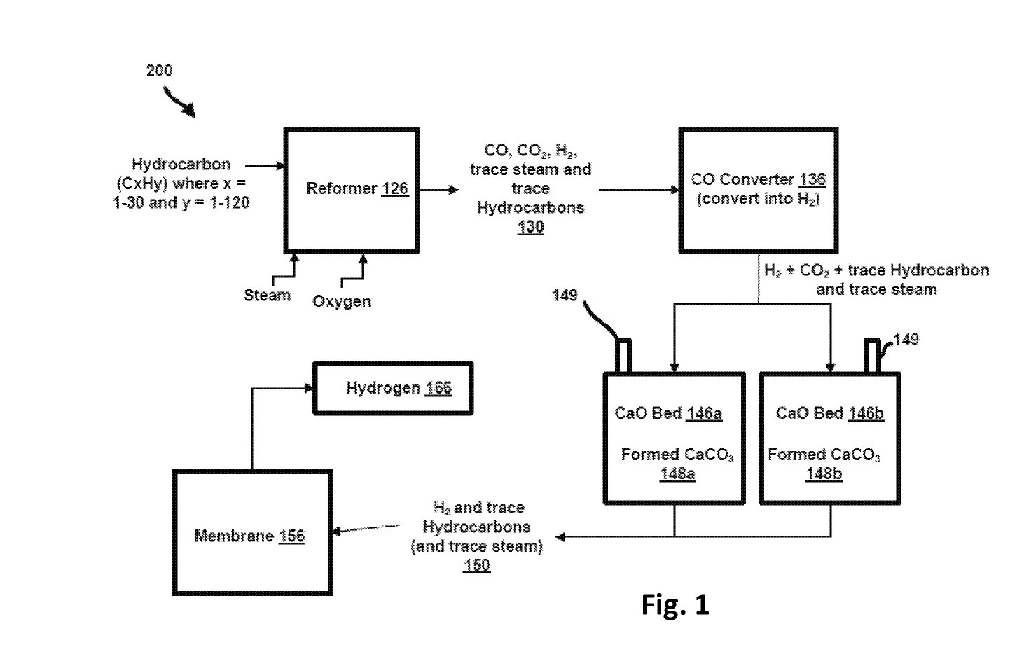

The present embodiments relate to chemical processes that may be used to separate hydrogen gas from the other products that were formed during a reforming process. Accordingly, FIG. 1 shows a process 200 whereby hydrogen 166 may be separated from the other products and may be obtained. Once obtained, the hydrogen may then be used for further reactions during a refining process. Alternatively, the hydrogen may be sold or otherwise reacted.

In the method 200, a reformer 126 is used. This reformer 126 may be a Steam Methane Reformer, such as the type known in the art. However, any other type of reformer may be used. For example, the reformer 126 may be a plasma reformer that is used to form diesel fuels or other hydrocarbons. In other embodiments, the reformer may be a catalytic reformer that is used to react with the hydrocarbons. In yet additional embodiments, the reformer 126 may be an “ITM reformer”. An example of an ITM reformer 126 is shown in FIG. 1A. In this embodiment, a MEOS reformer 126a is illustrated. “MEOS” stands for mixed electrolyte oxygen system. This MEOS reformer 126a takes air 130b and methane 130a and reacts these materials to form CO 130c and hydrogen gas 130d.

Referring again to FIG. 1, other types of reformers may also be used as the reformer 126, include a microchannel reformer that is typically used in the industry or a molten salt reformer. These types of molten salt reformers are available from the Western Hydrogen Company of Calgary Canada. One example of such a reaction is disclosed in U.S. Pat. No. 8,309,049, which patent is expressly incorporated herein by reference. FIG. 1B shows an example of the reaction that occurs in a molten salt reformer. In this reaction, water, carbon compounds and sodium salts are reacted to obtain hydrogen and carbon dioxide. Those skilled in the art will appreciate that other types of reformers may also be used. In some embodiments, the reformer 126 is a partial oxidation reformer that will, at least partially, oxidize the hydrocarbon. Any other device that can at least partially oxidize the hydrocarbon can be used as the reformer.

Steam, oxygen and the hydrocarbon may be added to the reformer. The hydrocarbon may have carbon and hydrogen atoms, as shown.

As shown in FIG. 1, the products coming out of the reformer 126 may include trace steam, CO, CO₂, H₂, trace amounts of hydrocarbons (which may be methane, CₙHₘ, etc.), and perhaps, nitrogen and oxygen. (This mixture of products is designated as numeral 130). In some embodiments, CO may not be present, and as such, the output of the reformer 126 may go directly into the CaO bed 146a, 146b. (This CaO bed will be described in greater detail below).

However, if CO is present in the mixture 130, then a CO converter apparatus 136 may be employed. In some embodiments this removal device may be another type of reformer. A catalyst may be used to facilitate/speed up this reaction. Also, air/oxygen may be used, as desired. However, any type of device that is capable for removing CO from the mixture 130 may be used. The converter 136 may be any device that converts at least part of the mixture into hydrogen gas.

The output of the CO converter 136 may include a mixture of hydrogen, trace amounts of hydrocarbons, trace amounts of steam nitrogen, oxygen and/or CO₂. As shown in FIG. 1, this mixture may be output into a CaO bed 146a, 146b. The CaO beds 146a, 146b are positioned in parallel such that one of the beds 146a, 146b is receiving the output while the other bed 146a, 146b is not receiving the output. (The purpose of having these CaO beds positioned “in parallel” will be described herein.)

The CaO beds 146a, 146b may include a quantity of CaO such as gypsum. A catalyst bed may also be included within the CaO beds 146a, 146b. When the gases enter the CaO beds 146a, 146b, the CO₂ will react with the CaO to form CaCO₃. The catalyst may further be used to facilitate/speed up this reaction. In some embodiments, this reaction may occur at a temperature between 300-600° C. Of course, a heat exchanger, a thermocouple, etc., may be part of the CaO beds 146a, 146b in order to facilitate the reaction, optimize the heat transfer, etc.

The CaO bed will effectively remove the CO₂ from the quantity of gases. Thus, exiting the CaO bed may be a mixture 150 of hydrogen and hydrocarbons. (Nitrogen and oxygen may or may not be present in the mixture 150 as well, along with trace amounts of hydrocarbons and trace amounts of steam.) This mixture 150 may then be added to a membrane 156 that is specifically designed to separate out hydrogen gas from other materials. Thus, the output hydrogen 166 from the membrane 156 may be highly pure hydrogen that may then be used in refining reactions, sold, etc. At the same time, because the CO₂ and CO were previously removed from the mixture 150, the likelihood of “coking” occurring during membrane separation is significantly reduced and/or eliminated.

The purpose of having two beds 146a, 146b in parallel will now be described. Specifically, as the CaO is reacting with CO₂, CaCO₃ 148a, 148b will be formed. After time, the entire quantity (or a significant quantity) of the CaO will be consumed. Accordingly, in order to regenerate the CaO, the CaCO₃ will be heated to a temperature between 800-1200° C. Such heating of the CaCO₃ releases the CO₂ and regenerates the CaO. In turn, the formed CO₂ may then be vented out through a CO₂ outlet 149. Once the CO₂ has been vented, the CaO is ready to react with another batch of CO₂. By placing the two beds 146a, 146b in parallel, one of the beds may be operating (e.g., reacting with CO₂) while the other bed is being heated to convert the CaCO₃ into CaO. Once the first bed has been reacted, the function of the two beds can switch—e.g., the second bed will react with the gases while the first bed is heated to regenerate the CaO. In this way, one bed is always reacting while the other bed is regenerating the CaO, thereby ensuring that the process can be run continuously without the need to shut off the process while the CaO is being regenerated.

Because the beds 146a, 146b will fluctuate between 300-600° C. during reactions and 800-1200° C. during CaO regeneration, the beds may be designed with heat exchangers, heat capture devices, thermocouples, etc., so as to capture/re-use the heat as needed. These types of devices are known in the art. Those skilled in the art will appreciate how the beds 146a, 146b may be designed so that they are as efficient as possible.

As shown in FIG. 1A, once the CO 130c and hydrogen 130d are formed from the mixed ion conductor 126, steam may be added to convert the CO into carbon dioxide. Then quantity of carbon dioxide and hydrogen may then be reacted with parallel CaO beds, in the manner outlined herein, thereby forming hydrogen gas.

As shown in FIG. 1B, steam and hydrocarbon compounds may be added to a molten salt reformer, thereby producing hydrogen, carbon dioxide, steam (which may be in trace amounts) and hydrocarbons (which may be in trace amounts). This mixture may then be added to parallel CaO beds to form hydrogen gas in the manner outlined herein.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method of separating hydrogen gas from other products produced by a reformer comprising:
adding the products to a CaO bed, wherein the CaO bed removes CO₂ from the products and forms a stream of hydrocarbons and hydrogen;
processing the stream of hydrocarbons and hydrogen with a membrane, wherein the membrane separates out the hydrogen.

2. The method as in claim 1, further comprising removing CO from the products before the products are added to the CaO bed.

3. The method as in claim 1, wherein the CaO bed reacts with the CO₂ to form CaCO₃, wherein the CaCO₃ may be heated to regenerate the CaO and CO₂, wherein the regenerated CO₂ is vented out through a vent.

4. The method as in claim 3, wherein there are two CaO beds placed in parallel.

5. The method as in claim 1, wherein the reformer is a Steam Methane Reformer.

6. The method as in claim 1, wherein the reformer is selected from the group consisting of:
a plasma reformer;
a MEOS reformer;
a microchannel reformer;
a catalytic reformer; and
a molten salt reformer.

7. The method as in claim 1, wherein the reformer at least partially oxidizes the hydrocarbon.
